(19) United States
(12) Patent Application Publication
(10) Pub. No.: US 2020/0245597 A1
(43) Pub. Date: Aug. 6, 2020

(54) Center Balanced Suet Bird Feeder

(71) Applicant: Timothy McCown, Bellaire, MI (US)

(72) Inventor: Timothy McCown, Bellaire, MI (US)

(21) Appl. No.: 16/268,057

(22) Filed: Feb. 5, 2019

(51) Int. Cl. A01K 39/01

(52) U.S. Cl. CPC A01K 39/0113; A01K 39/0106

(57) ABSTRACT

The technology involved in this bird feeder is simply the resultant of naturally occurring consequences of applying force to a centrally balanced device. When any device, in this case a bird feeder, is hanging from its central point of balance any force applied to any point on the perimeter of this device will cause a condition of unbalancing the device. This force causing the unbalancing results in the whole device tilting away from the force applied instantaneously. In this case that is desirable to thwart squirrels from getting a foothold on the suet container thus denying them the feast they are seeking.

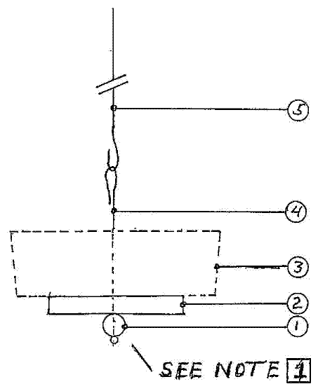

This invention is a very simple kit for hanging a commercially manufactured package of suet bird feed. These are commonly plastic containers approximately 4½ inches square by approximately 1½ inches deep. The kit instructions will indicate that the container must be turned upside down. The kit will include a device to puncture the plastic container at the center point. The center point will be indicated by a pattern included in the kit. A straight wire shaft will be put through a bead; then the wire shaft (already through the bead) will be put through the support platform; then the wire shaft will be inserted through the hole in the bottom of the plastic container of suet, through the suet to extend above the suet. The wire shaft is bent over to form a hook. This hook will slip through the hook on the end of the hanging wire. These steps complete the feeder which will be ready to hang at a location to start feeding birds and frustrating squirrels.

The drawing included with this patent application indicates materials and sizes of those materials that will vary, including lengths, thickness, and diameters. Item #1 in the parts list, the bead, will not always be plastic and 16 mm diameter. It might be glass, wood, metal, fiber glass, carbon fiber, or any other available material in whatever diameter I decide to use. The diameter is irrelevant to the function.

Item #2 in the parts list is the support platform. This platform will not always be wood. It may be metal, plastic, fiber glass, carbon fiber or any other material I might want to use. It also may vary in size from 3½ inch square.

Item #4 in the parts list shown is the straight wire shaft with closed eye four inches in length and 0.026 diameter. This straight wire shaft hanging wire may vary in length and diameter used. It may or may not be a closed eye. (This particular item described is used in fishing tackle. Specifically used for lures with spinners for attracting larger fish.) I could use a straight piece of wire and bend a loop on the end so it won't slide through the bead.

Item #5 in the parts list is the wire included to hang the feeder at the location chosen by the user. The material used for hanging the feeder does not necessarily have to be wire. It could be a small chain, or rope, or any other material that I might choose. This hanging wire may vary from 20 gauge wire to any other gauge that will function as a hanging wire. It may also vary in length to any length that will reasonably hang the feeder.

1. This simple suet bird feeder hanging kit is unique because the suet container is hung from its central point of balance. This concept defeats squirrels attempting to jump onto the suet container to start devouring the contents. As soon as the squirrel touches any point on the perimeter of the suet container it instantaneously tilts away from any weight applied to it. The squirrel is immediately clawing at air and is falling to the ground. The birds are much lighter in weight and have no problem landing on the suet and feeding. This very inexpensive bird feeder is very easy to assemble. The plastic bead that the wood platform sets on helps to level the feeder. However, as the birds eat the suet on one side of the container the weight loss causes the feeder to begin to tilt. The birds have had no problem consuming the contents even if it is hanging in a vertical position. This is a bare bones bird feeder that is easy to refill when it is necessary.
